(19) United States
(12) Patent Application Publication
(10) Pub. No.: US 2005/0262028 A1
(43) Pub. Date: Nov. 24, 2005

(54) Method for the conveyance of postal items and package mailbox

(75) Inventors: Boris Mayer, Bonn (DE); Barbara Buesch, Asbach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post A G, Bonn (DE)

(21) Appl. No.: 10/524,243

(22) PCT Filed: Aug. 8, 2003
(86) PCT No.: PCT/DE03/02684

§ 371 Date: Feb. 10, 2005

(30) Foreign Application Priority Data
Aug. 16, 2002 (DE) 102 38 342.1

(51) Int. Cl. G06F 17/60

(52) U.S. Cl. 705/406

(57) ABSTRACT

The disclosure relates to a method for the conveyance of a postal item, whereby an identification code is assigned to the postal item. The postal item is delivered to a box of an electronic package mailbox, and the identification number of the postal item is recorded and stored in the electronic package mailbox and/or a central databank. The disclosure further relates to an electronic package mailbox, which includes means for recording an identification code for postal items and subsequently transmitting the identification code to a data processing unit for storage of transport data.

The invention relates to a method for the conveyance of postal items using an electronic parcel compartment system in which, when a mailpiece is deposited, the electronic parcel compartment system records identification information that identifies the mailpiece and/or it generates said identification information, and in that, during subsequent processing steps of the mailpieces, the identification information is recorded and/or evaluated in a data processing unit that stores transport data, and the identification information is stored in the electronic parcel compartment system and/or in a central data processing unit.

A method of this type is known from French patent application FR 2 563 987. In this prior-art method, mailpieces are transported to an electronic parcel compartment system. The recipients of the mailpiece can identify themselves as being authorized recipients at the electronic parcel compartment system and they can then remove the parcel.

Moreover, international patent application WO 01/31593 A1 discloses a locker system for delivering ordered shipments in which the shipments are identified by means of an identification code. When a shipment is picked up by a recipient, the recipient is identified and a payment for the shipment can be carried out or initiated at the compartment system. In addition to the delivery of shipments, the original recipient can also use the compartment system to return shipments. Here, when such returns are deposited, preferably the identification assigned to the shipment is likewise recorded and the original recipient is credited for the amount of the original purchase price of the ordered product.

International patent application WO 01/00069 A2 discloses a postbox in which shipments for a recipient can be deposited. Preferably, the postbox belongs to the recipient in question or else he can rent it for a certain period of time. Here, it is also possible for several shipments to be deposited consecutively into a box. The checking procedure for authorizing the opening of the postbox can involve not only the checking of the identification of the deliverer or recipient but also access can be denied, for example, if there is already an object of great value in the box. The postbox is also suitable for the owner to deposit shipments for pick-up and for delivery by a delivery service. Here, the owner can place the shipment into the postbox and the calculation of the fee charged for the transport can be entered by the owner, after which the amount is debited from his account. In another disclosed embodiment of the invention, the deliverer removes the shipment, determines the requisite transport fee, franks the shipment as necessary, and initiates the debiting of the transport fee from an account of the owner.

International patent application WO 01/52199 A2 likewise discloses an electronic compartment system for the depositing of shipments for pick-up by an authorized recipient. When a shipment is picked up by a recipient, the identification of the recipient is checked and, if applicable, a payment for the shipment can be effectuated at the compartment system. The payment can be made, for example, by inserting money directly into the machine or else the payment can be debited from a user account, whereby the amount to be paid can depend on the size of the compartment and/or on the duration of the rental. The compartment system also allows the recipient to send shipments back. In this case, the original recipient places the shipment into a compartment and a deliverer is informed that a shipment has been deposited for pick-up.

International patent application WO 01/141605 A3, for example, describes a device for accepting shipments, said device preferably being in the area of the owner of the device. The device has a closed area for depositing small mailings such as letters, which can be inserted, for example, through a conventional mailbox slit. As a complement to this, the device has a second closed area into which or from which authorized persons can deposit or remove larger shipments such as parcels.

Moreover, German Preliminary Published Application. DE 100 33 664 A1 discloses a device and a method for delivering ordered goods in the absence of the recipient. Here, preferably at the time of the ordering of the goods, the deliverer receives an identification key with which he is authorized to open the storage device. The access key is preferably invalid after being used and consequently can only be used once.

The invention is based on the objective of further developing prior-art methods and devices in such a way that a better utilization of the capacities of the electronic parcel compartment system is achieved, whereby the electronic parcel compartment system can be used to accept mailpieces and to subsequently forward the mailpieces to recipients outside of the service area of the electronic parcel compartment system.

According to the invention, the objective is achieved by a method according to the independent claim 1. Practical refinements of the invention are found in the subordinate claims 2 to 7.

The invention provides that, when a mailpiece is deposited, the electronic parcel compartment system records identification information that identifies the mailpiece and/or it generates said identification information, and in that, during subsequent processing steps of the mailpieces, the identification information is recorded and/or recorded and evaluated in a data processing component that stores transport data.

The execution according to the invention of the method, or the configuration according to the invention of the electronic parcel compartment system, make it possible to use the electronic parcel compartment system to accept mailpieces and to subsequently forward the mailpieces to recipients outside of the service area of the electronic parcel compartment system.

This means in particular that the electronic parcel compartment subsequently forward the mailpieces to recipients outside of the service area of the electronic parcel compartment system.

This means in particular that the electronic parcel compartment system can be used for dispensing mailpieces as well as for receiving mailpieces. In this manner, storage capacities of the electronic parcel compartment system as well as the transportation space in means of transportation such as, for example, vehicles, are used more effectively for the conveyance of the mailpieces.

Preferably, a deliverer removes mailpieces from the electronic parcel compartment system that are there temporarily and that are intended for further transport within a logistic system and said deliverer then deposits mailpieces into the electronic parcel compartment system that can subsequently be picked up by users of the electronic parcel compartment system in the area of the electronic parcel compartment system.

Preferably, the invention allows the most flexible possible filling of the compartments as well as the utilization of the fact that the available storage capacity of the electronic parcel compartment system is increased in that mailpieces meant for further transport in the logistic system have been removed.

An especially preferred embodiment of the invention is characterized in that the identification information is recorded when the mailpiece is deposited as well as when the mailpiece is removed from the electronic parcel compartment system.

Fraudulent use of the electronic parcel compartment system is prevented in that only mailpieces that have been properly recorded are forwarded to a subsequent conveyance cycle.

In an especially preferred embodiment of the invention, before being delivered to the parcel compartment system, all of the mailpieces already have the identification code and/or the address sticker. This is especially the case with returned items.

An especially preferred embodiment of the invention is characterized in that the same means can be used for the transmission of the event information about the delivery and/or pick-up of mailpieces that can also be used for the transmission of the identification information.

Both variants entail specific advantages. For example, the shared transmission of the information about the pick-up or the delivery of the mailpieces and the simultaneous transmission of the identification information allows comprehensive shipment tracking.

A combination of the various transmission means results in the highest possible assurance of payment for the shipping company that operates the logistic system as well as in the most comprehensive possible shipment tracking.

Moreover, a combination is suitable for returned items as well as for already franked shipments such as, for example, prepaid parcel products. It is also possible to establish and utilize a separate parcel stamp for the delivery of parcels to electronic parcel compartment systems or to adapt the current payment model of the freeway parcel stamp so as to attain a purely size-dependent scale.

Preference is given to the acceptance of franked mailings, especially since the service at the machine can be completed relatively quickly in this case. The customer merely has to scan the label into the machine.

It is especially advantageous if the customer with the parcel acceptance function has the possibility to select a sender within the Deutsche Post World Net corporation. For example, after the shipment has been properly deposited, the customer can preferably choose between several types of delivery. Here, for instance, a ‘normal delivery’ and an ‘express delivery’ can be available as choices. If the customer selects ‘express delivery’, he might then be requested to pay an appropriate additional amount by means of an EC card or money card. The procedure in the case of an express delivery can then, for example, be that the electronic parcel compartment system triggers a notification (by SMS or e-mail) with the necessary information (where the shipment can be picked up, by when the shipment has to be delivered where, . . . ) to the logistic company. Consequently, with the modality of express deliveries, a prompt pick-up of the shipment can be ensured.

Additional advantages, special features and practical refinements of the invention are found in the subordinate claims and in the description below of preferred embodiments, making reference to the drawings.

The drawings show the following:

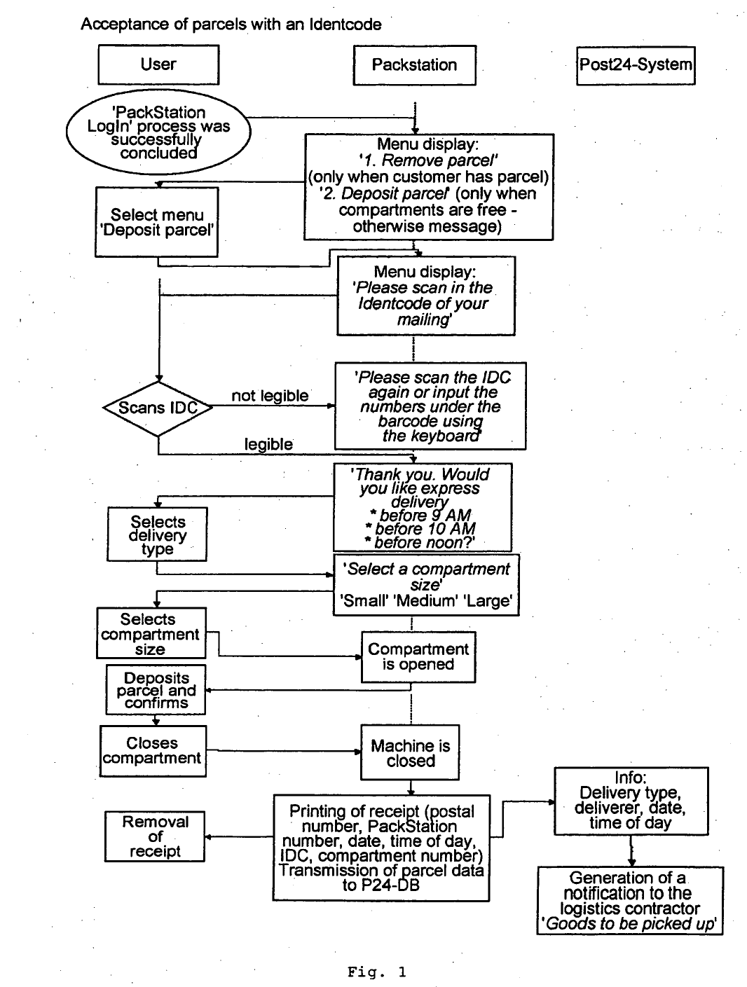

FIG. 1 a block diagram with an especially preferred acceptance modality of parcels with an Identcode,

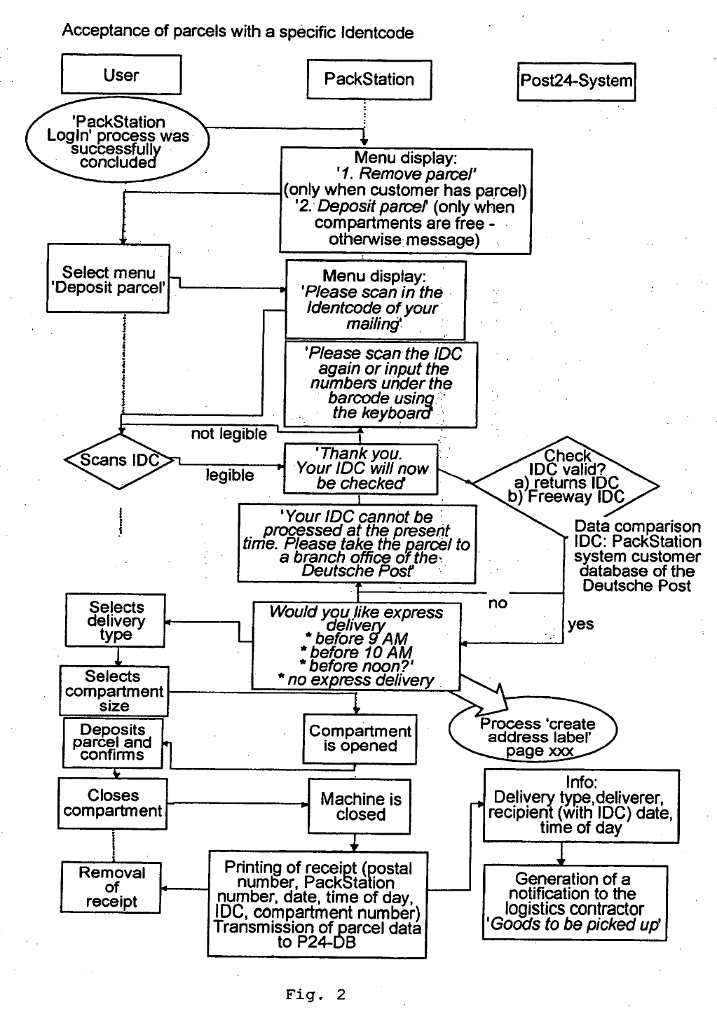

FIG. 2 a block diagram with an especially preferred acceptance modality of parcels with a specific Identcode, and

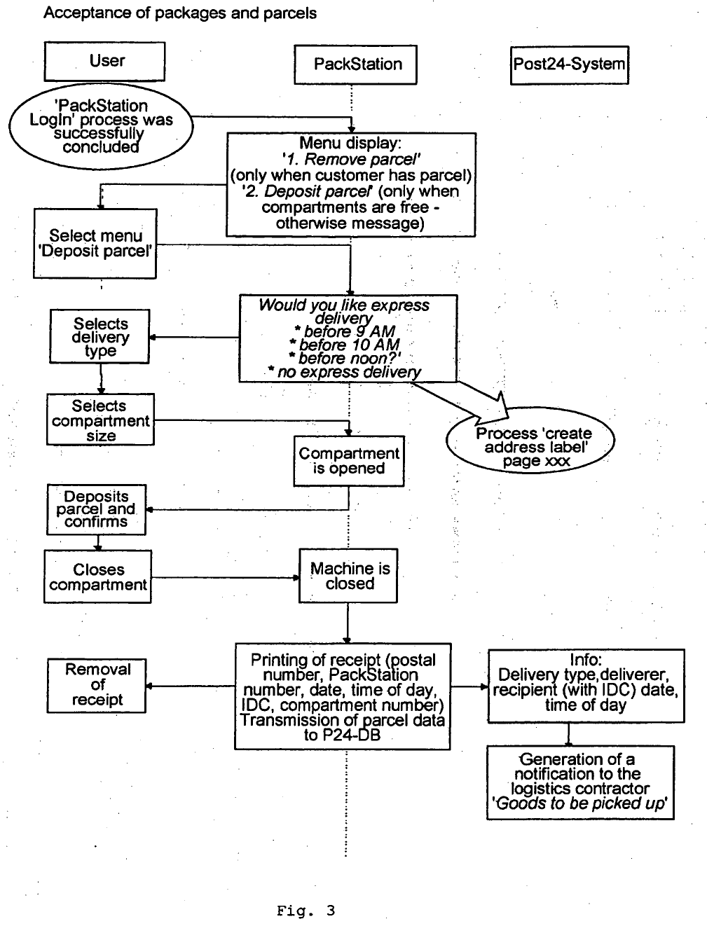

FIG. 3 a block diagram with an especially preferred acceptance modality of parcels and packages.

### FRANKING OF SHIPMENTS

If only franked shipments can be accepted at the machine, then they have to be sufficiently franked.

Numerous senders enclose return labels, including return codes, with their shipments. Return codes are separate sets of numbers that are assigned only to returns. The transport costs for return codes are invoiced by the Deutsche Post subsequently (that is to say, after the recipient has sent the shipment back to the sender).

The sender—depending on the goods management system or customer administration system—associates the return codes to the order. This means that, by knowing the return code, the sender can identify the shipment or the possible contents of the returned items.

The sets of numbers of the Identcodes and return codes of business customers of the Deutsche Post are stored in a central database. A link to this database allows the Identcodes or return codes to be checked. If the return codes are known in the system, they can easily be forwarded to the sender. Thus, for example, the additional service “notification of the returns” could be offered to the senders.

Sending parcels

a) ELECTRONIC PARCEL COMPARTMENT SYSTEM variant

The shipment has to have an Identcode. The Identcode is scanned into the machine and checked on the basis of the check digit logic. If the Identcode is correct, the shipment can be accepted. If the scanned code is not correct or if it is not an Identcode, then the placement of the shipment is refused.

In an especially preferred embodiment of the invention, not only the Identcode but also a routing code (Leitcode) that is applied onto the shipment is checked. Here, the routing code is advantageously checked for the number of digits, hash value and for specific return product codes that constitute part of the routing code. This increases the security in the checking of return shipments and the customer is requested, for example, to scan both barcodes on his return sticker.

b) New Parcel Stamp

A conceivable further refinement for the acceptance of parcels is the acceptance of shipments with certain Identcodes and routing codes (or return codes) that can be checked by the electronic parcel compartment system. For example, in a manner similar to the freeway stamp, there could be an PARCEL COMPARTMENT SYSTEM STAMP—one price for all parcels or a price scale on the basis of the compartment size—that would no longer be calculated as a function of the size and weight.

Each FREEWAY STAMP contains an Identcode. The sets of numbers used for each label (S, M, L, XL, F) are related directly to the size of the compartment (S, M, L, XL). If an Identcode of a FREEWAY STAMP S parcel stamp is scanned in, only a small compartment opens. If all of the small compartments are occupied, then the next larger compartment opens as needed.

Acceptance of Parcels with an Identcode

A block diagram depicting an especially preferred acceptance modality for parcels with an Identcode is shown in FIG. 1. Only parcels—that is to say, shipments for which verification of the identity is required—are accepted in the electronic parcel compartment system. A correct Identcode and routing code are needed to open the compartment.

Especially preferred embodiments:
logic for IDC check
logic for routing code check including product check
set-up of a scanning process in the machine that is reliable and simple for the customer
simple, self-explanatory or intuitive machine operation

Sequence:
1. The LogIn procedure is successfully completed by the customer.
2. The user chooses in the menu between ‘remove parcel’ (only appears if the user has parcels in the machine) and ‘deposit parcel’ (only appears if compartments are free and if the user is authorized to deposit parcels)
3. The user chooses ‘deposit parcel’ and is prompted to scan in the two barcodes (Identcode and routing code) of his shipment. (If the scanning fails, it is preferable if manual entry is possible.)
4. Both codes (Identcode and routing code) are checked on the basis of the check digit.
5. If the codes are correct, the user is optionally asked about the type of delivery.
6. The user is prompted to select a compartment size.
7. After selection of the size, an appropriate compartment is opened.
8. The user deposits the parcel and closes the door.
9. The machine prints a receipt (information: postal number; number of the electronic parcel compartment system; date and time of day; IDC; compartment number; logistic provider).
10. The user removes the receipt.
11. The parcel data (see 9.) is forwarded to the Post24 System. From there, the information of the logistic provider can be initiated, if applicable.

Acceptance of parcels with an Identcode

Risks
shipments might be insufficiently franked
shipments might be incorrectly addressed
different shipments from what the scanned-in codes (Identcode and routing codes) would lead to expect might be deposited (e.g. shipments without IDC)
final customers might not be good at handling scanners

Various embodiments for the electronic parcel compartment system

In addition to the DPWN customer model, other embodiments are also conceivable. In the embodiment of the DPWN, it is necessary to identify the recipient. Over a certain period of time, the Deutsche Post has to be able to substantiate to whom which shipment was given (only with shipments for which verification of the identity is required).

Requirements

DPWN Customer Model

Existing concept for customer-specific depositing and picking up of goods in and at electronic parcel compartment systems.

Here, the unambiguous identification of each parcel recipient is important. Each user who can pick up parcels has to be registered. For this purpose, the postal address is verified by means of an address check and the identity of the customer is verified on the basis of the PostPIN received by registered letter. In this manner, all customer data is verified. Unverifiable customers are not accepted.

Shipments are only deposited for (known and registered) recipients.

It is especially advantageous for the deliverer to indicate the postal number when the shipment is deposited since this allows a notification to be sent to the recipient.

At the machine, the user identifies himself with his postal number and his PostPIN. In this way, the electronic parcel compartment system knows who the person picking up each parcel is.

Prerequisites
address has been checked
customer identity has been verified
customer is registered
shipment is addressed to customer (with postal number)
shipment was deposited into the machine correctly
customer login to the electronic parcel compartment system was concluded successfully

Sequence
1. The address contains the postal number of the recipient.
2. The deliverer deposits the shipment, indicating the postal number.
3. On the basis of the recipient identity, the notification can be initiated.
4. The customer logs in at the machine with his postal number (gold card).
5. He identifies himself by entering his PostPIN.
6. If the checking of the postal number/PostPIN combination is successful, the customer can use the electronic parcel compartment system. If the combination is not correct, the customer is refused access.

1-11. (canceled)

12. A method for conveying mailpieces using an electronic parcel compartment system, wherein when a mailpiece is deposited, the electronic parcel compartment system records and/or generates identification information that identifies the mailpiece, and, during subsequent processing steps of the mailpieces, the identification information is recorded and/or evaluated in a data processing unit that stores transport data, and the identification information is stored in the electronic parcel compartment system and/or in a central data processing unit, wherein the identification information contains monetary information, in the area of the electronic parcel compartment system, the method comprising the steps of carrying out a payment checking procedure to confirm the presence of at least one of a monetary amount and monetary information in a predefinable amount, and activating an access possibility for depositing a mailpiece, if the payment checking procedure has confirmed the presence of at least one of said monetary amount and said monetary information, and relating the size of the compartment that opens directly to a set of numbers of the recorded identification information and opening a compartment of the appropriate size for a set of numbers of a certain price class.

13. The method of claim 12, comprising recording the depositing of the mailpiece into the electronic parcel compartment system in a data processing unit that stores transport data.

14. The method of claim 12, comprising the data processing unit that stores transport data sending a digital notification message for picking up the parcel.

15. The method of claim 12, wherein at least one of the notification message and the identification information contains information about the transport of the mailpiece, and comprising the setup of effecting the transport of the mailpiece at least partially on the basis of this information.

16. The method of claim 12, comprising recording the identification code when the mailpiece is deposited and when the mailpiece is removed from the parcel compartment system by a deliverer.
